(19) United States
(12) Patent Application Publication
(10) Pub. No.: US 2025/0244925 A1
(43) Pub. Date: Jul. 31, 2025

(54) NON-TRANSITORY COMPUTER-READABLE STORAGE MEDIUM STORING CONTROL PROGRAM, CONTROL APPARATUS, AND UPDATE METHOD

(71) Applicant: SEIKO EPSON CORPORATION, Tokyo (JP)

(72) Inventor: Yohei KONDO, Nagano (JP)

(21) Appl. No.: 19/038,761

(22) Filed: Jan. 28, 2025

(30) Foreign Application Priority Data
Jan. 30, 2024 (JP) 2024-011745

(51) Int. Cl. G06F 3/12

(52) U.S. Cl. CPC G06F 3/123; G06F 3/1204

(57) ABSTRACT

According to an aspect of the present disclosure, there is provided a non-transitory computer-readable storage medium storing a control program, the control program causing a computer to execute acquisition processing, determination processing, and update processing. In the acquisition processing, apparatus information on an image processing apparatus is acquired from a general-purpose driver. In the determination processing, necessity of updating an external program related to the image processing apparatus is determined based on the acquired apparatus information. In the update processing, the external program is updated when it is determined in the determination processing that the external program is required to be updated.

The present application is based on, and claims priority from JP Application Serial Number 2024-011745, filed Jan. 30, 2024, the disclosure of which is hereby incorporated by reference herein in its entirety.

### BACKGROUND

### 1. Technical Field

The present disclosure relates to a non-transitory computer-readable storage medium, a control apparatus, and an update method.

### 2. Related Art

JP-A-2021-43547 discloses a technique for reducing the time and effort of a user required for downloading and installing a driver specific to a printer vendor even in an environment where an operating system (OS) standard printer driver is installed.

The technique described in JP-A-2021-43547 is to execute printing using an installed driver specific to the printer vendor without using an OS standard printer driver. On the other hand, in an environment where printing processing is performed using a general-purpose printer driver such as an OS standard printer driver, an application program provided by a vendor of a printer or a firmware program of the printer cannot be automatically updated. Therefore, in such an environment, the user is required to manually update the program, and the update takes time and effort.

Therefore, it is desired to develop a technique capable of easily updating a program related to a printer provided by a vendor of the printer, for example, in an environment where printing processing is performed using a general-purpose printer driver. In addition, even in an environment where image processing is performed using a general-purpose driver that controls another type of image processing apparatus different from a printer, it is desired to develop a technique capable of easily updating a program related to the image processing apparatus provided by, for example, a vendor of the image processing apparatus.

### SUMMARY

According to an aspect of the present disclosure, there is provided a non-transitory computer-readable storage medium storing a control program, the control program causing a computer to execute: acquisition processing of acquiring apparatus information on an image processing apparatus a from general-purpose driver; determination processing of determining necessity of updating an external program related to the image processing apparatus based on the acquired apparatus information; and update processing of updating the external program when it is determined in the determination processing that the external program is required to be updated.

According to an aspect of the present disclosure, there is provided a control apparatus including: a general-purpose driver; an acquisition processing unit configured to acquire apparatus information on an image processing apparatus from the general-purpose driver; a determination processing unit configured to determine necessity of updating an external program related to the image processing apparatus based on the acquired apparatus information; and an update processing unit configured to update the external program when the determination processing unit determines that the external program is required to be updated.

According to an aspect of the present disclosure, there is provided an update method including: acquisition processing of acquiring apparatus information on an image processing apparatus from a general-purpose driver; determination processing of determining necessity of updating an external program related to the image processing apparatus based on the acquired apparatus information; and update processing of updating the external program when it is determined in the determination processing that the external program is required to be updated.

### BRIEF DESCRIPTION OF THE DRAWINGS

FIG. 1 is a block diagram showing a configuration example of a printing system according to Embodiment 1.

FIG. 2 is a sequence diagram illustrating a first example of update processing in the printing system shown in FIG. 1.

FIG. 3 is a diagram showing an example of a user interface image displayed by a vendor assistance application program in the update processing shown in FIG. 2.

FIG. 4 is a sequence diagram illustrating a second example of the update processing in the printing system shown in FIG. 1.

FIG. 5 is a block diagram showing a configuration example of a printing system according to Embodiment 2.

FIG. 6 is a sequence diagram illustrating a first example of update processing in the printing system shown in FIG. 5.

FIG. 7 is a sequence diagram illustrating a second example of the update processing in the printing system shown in FIG. 5.

FIG. 8 is a sequence diagram continuing from FIG. 7.

FIG. 9 is a diagram showing an example of a hardware configuration of an apparatus.

### DESCRIPTION OF EMBODIMENTS

Hereinafter, embodiments of the present disclosure will be described with reference to the drawings. The drawings are merely an example showing the embodiment of the present disclosure. Not all of the components described in the embodiments of the present disclosure are essential components of the present disclosure.

In the following embodiments, a printing system including a printing apparatus as an example of an image processing apparatus will be described as an example of an image processing system.

### Embodiment 1

### System Configuration

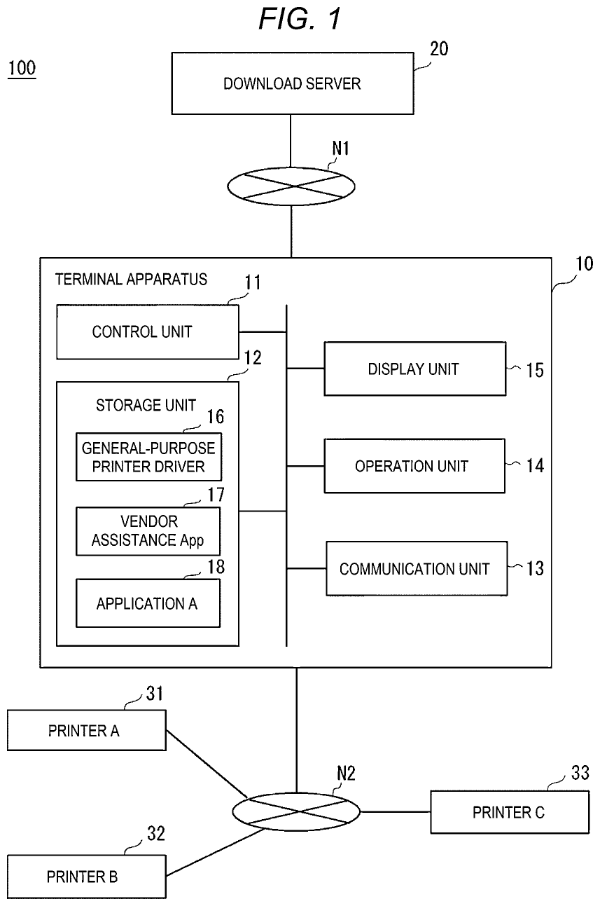

A configuration example of a printing system according to Embodiment 1 will be described with reference to FIG. 1. FIG. 1 is a block diagram showing the configuration example of the printing system according to the embodiment.

As shown in FIG. 1, a printing system 100 according to the embodiment may include a terminal apparatus 10, a download server 20, a printer A (31), a printer B (32), and a printer C (33).

The terminal apparatus 10 is an information processing apparatus having a communication function of a personal computer (PC), a smartphone, a tablet terminal, or the like, and may be used by a user who desires printing. For processing of transmitting printing requests, the terminal apparatus 10 is connected to the printer A (31), the printer B (32), and the printer C (33) via a network N2. Although not shown, the printing system 100 may include a plurality of terminal apparatuses 10.

The printer A (31), the printer B (32), and the printer C (33) are examples of a printing apparatus, and can print on a medium when printing data is received. The printers produce printed matter by performing such printing. For convenience, it is assumed that the printing system 100 includes three printers as described above, and the printing system 100 may include at least one printer. The printers may be apparatuses having a communication function and a printing function, or may be multifunction peripherals having other functions such as a scanner function, a copy function, and a facsimile transmitting function. The printers may also be referred to as printing apparatuses or image forming apparatuses. A printing method in the printers is not limited, and various printing methods such as an inkjet printing method and a laser printing method can be applied.

The printing system 100 performs printing by a printer selected from the printer A (31), the printer B (32), and the printer C (33) by a user operation of the terminal apparatus 10.

The terminal apparatus 10 is connectable to the download server 20 via the network N1. The terminal apparatus 10 accesses the download server 20 and downloads an update program for updating an installed program. The update program may also be called an installer. The terminal apparatus 10 may also be referred to as a control apparatus or an update apparatus because of performing such control.

The download server 20 is a server that stores the update program for updating various application programs in a state where the update program can be downloaded by the terminal 10 so as to be provided to the terminal apparatus 10. The download server 20 may also store various application programs themselves in a state where the various application programs can be downloaded by the terminal apparatus 10 so as to be provided to the terminal apparatus 10. The download server 20 may be a server that collectively manages and discloses a plurality of application programs provided by a vendor of the printer. That is, the above-described various application programs can be application programs provided by the printer vendor.

Therefore, although not shown, the download server 20 may include a storage unit that stores a program and an update program to be provided, a communication unit that communicates with the terminal apparatus 10 via the network N1, and a control unit that controls the entire download server 20. In the present specification, the server refers to a server computer or a server apparatus.

Hereinafter, a configuration example of the terminal apparatus 10 will be described in detail. The descriptions of the configuration example of the download server 20 and the printers are omitted.

### Configuration of Terminal Apparatus 10

As shown in FIG. 1, the terminal apparatus 10 may include a control unit 11, a storage unit 12, a communication unit 13, an operation unit 14, and a display unit 15.

The control unit 11 controls the entire terminal apparatus 10. The control unit 11 may include, for example, a calculation processing apparatus, a working memory, and a storage apparatus that stores a control program, parameters, and the like. The calculation processing apparatus may be a central processing unit (CPU), a graphics processing unit (GPU), or the like. The control unit 11 may also be implemented as a system on a chip (SoC). As can be seen from the examples described above, the control unit 11 may have a configuration in which the control program is stored in an executable state. The control unit 11 may have a configuration in which a part of the control program is stored as a circuit configuration such as a field-programmable gate array (FPGA), or may be implemented as a dedicated circuit.

The above-described control program may include a program for causing the calculation processing apparatus to execute processing related to printing in cooperation with the storage unit 12, the communication unit 13, the operation unit 14, and the display unit 15. The above-described control program may include an OS. Since the OS is an OS installed in the terminal apparatus 10, the OS is of a type corresponding to a model or the like of the terminal apparatus 10. The above-described control program may include a Web browser in the OS or outside the OS. An example in which at least a part of the control program is stored in the storage unit 12 provided separately from the control unit 11 will be described below, and the storage unit 12 may be a part of the storage apparatus in the control unit 11. That is, the storage unit 12 may also be regarded as a part of the control unit 11.

The storage unit 12 is, for example, a storage apparatus including a hard disk drive, a solid state drive, or another memory. As a part of the control program, a general-purpose printer driver 16 and a vendor assistance application program 17 described below are stored in the storage unit 12 in a state where they can be executed by the control unit 11. Hereinafter, the vendor assistance application program will be abbreviated a vendor assistance App. In addition, the storage unit 12 can store various kinds of data such as a file to be printed.

The storage unit 12 stores an external program, which is a program related to a part or all of the printers and is different from the general-purpose printer driver 16 and the vendor assistance App 17, in a state where the external program can be executed by the control unit 11. The printers refer to printers connectable to the terminal apparatus 10, and are the printer A (31), the printer B (32), and the printer C (33) described above in the example shown in FIG. 1. For example, a program related to the printer A (31) includes an application program related to the printer A (31). The application program related to the printer A (31) may be an application program used for printing using the printer A (31) or editing a printing target file to be printed by the printer A (31). The application program related to the printer A (31) may be, for example, an application program provided by a vendor of the printer A (31).

In the embodiment, an example in which the external program is an application program installed in the terminal apparatus 10 will be described. The external program becomes a target for downloading, from the download server 20, an update program for update. A plurality of such external programs can be stored in the storage unit 12, and all of the external programs can be targets for downloading update programs. In order to simplify the description, an example in which one application A (18) is stored in the storage unit 12 as the target external program will be described below. Of course, the application A (18) itself may be an application program downloaded from the download server 20.

The communication unit 13 is a part that performs wireless or wired communication with an external apparatus such as the download server 20 via the network N1 in compliance with predetermined communication standards such as various vehicle communication standards and Wi-Fi (registered trademark. The same applies below.) standards. The communication unit 13 is a part that performs wireless or wired communication with an external apparatus such as the printer A (31), the printer B (32), and the printer C (33) via the network N2 in compliance with predetermined communication standards such as various vehicle communication standards a and Wi-Fi (registered trademark. The same applies below.) standards. The communication unit 13 can be implemented by one or a plurality of communication interfaces capable of performing these communications.

The operation unit 14 is a part that receives an operation performed by a user of the terminal apparatus 10, and may also be referred to as an operation reception unit. The operation unit 14 can be implemented, for example, by any one or more of physical buttons, a touch panel mounted on the display unit 15, a pointing device, a keyboard, and the like. In a configuration in which the operation unit 14 includes the touch panel, the operation unit 14 including the display unit 15 and the touch panel can be collectively referred to as an operation panel of the terminal apparatus 10.

The display unit 15 is a part for displaying a user interface (UI) image for operating the terminal apparatus 10 and is implemented by a display apparatus such liquid crystal display or as a an organic electroluminescence display. The display unit 15 may also include a display and a drive circuit that drives the display.

The general-purpose printer driver 16 will be described. The general-purpose printer driver 16 is an OS-standard printer driver that is provided in an OS included in the control program or attached to the OS. For example, the general-purpose printer driver 16 is a standard printer driver for a Windows (registered trademark. The same applies below.) OS. The general-purpose printer driver 16 may be a program that can control various types of printers to execute printing. The general-purpose printer driver 16 may also be referred to as an OS general-purpose printing program or a general-purpose printing program.

The general-purpose printer driver 16 is a driver that uses a general-purpose protocol for a search for a printer and printing in a printer. The general-purpose printer driver 16 uses, for example, mDNS/DNS-SD for the search for a printer, and uses IPP for the printing in the printer. Here, DNS is an abbreviation of Domain Name System. mMDNS is an abbreviation of multicast DNS. DNS-SD is an abbreviation of DNS Service Discovery. IPP is abbreviation of Internet Print Protocol.

As can be seen from this example, the general-purpose printer driver 16 may be, for example, an IPP Class driver. The IPP is an example of a standard protocol for controlling management and printing of a printer. The IPP acquires and controls printer information by a POST request and a response of Hyper Text Transfer Protocol (HTTP). In the IPP, printer setting and printer state acquisition can be performed. Here, secure communication can be performed by using HTTP Secure (HTTPS) instead of the HTTP.

The vendor assistance App 17 will be described. The vendor assistance App 17 is an application program assisting the general-purpose printer driver 16, and is used to expand the functions of the general-purpose printer driver 16. Therefore, the general-purpose printer driver 16 may have a function of starting the vendor assistance App 17 and transmitting a printing job to the vendor assistance App 17. The vendor assistance App 17 may be, for example, Print Support Application (PSA).

The vendor assistance App 17 may be a program for assisting the general-purpose printer driver 16 and causing a computer to execute printing control suitable for the performance of a target printer, that is, printing control for supporting a unique function of the printer. Here, the computer refers to the terminal apparatus 10 or the control unit 11. When acquiring a printing job from the general-purpose printer driver 16, the vendor assistance App 17 can convert the printing job such that printing using a unique function for a designated printer can be executed by the printer.

The vendor assistance App 17 is an application program provided by, for example, a vendor of a printer. The vendor assistance App 17 can be provided to the user of the terminal apparatus 10 by being disclosed in, for example, an application store of an OS provider. Alternatively, the vendor assistance App 17 can be provided to the user by being included in the OS or attached to the OS.

The vendor assistance App 17 includes a printing control program described below. That is, the printing control program can also be implemented as, for example, a PSA. Generally speaking, the printing control program may be a program for automatically handling updates of programs such as the application A (18).

Specifically, the printing control program is a program for causing a computer to execute acquisition processing, determination processing, and update processing as described below. Here, the computer also refers to the terminal apparatus 10 or the control unit 11. Hereinafter, an example in which the update target is the application A (18) will be described, and the update target may include other application programs.

In the acquisition processing, apparatus information on the printer A (31) is acquired from the general-purpose printer driver 16. The apparatus information may be referred to as device information or equipment information, and will be referred to as equipment information below. In this acquisition processing, the printing control program can acquire the equipment information through interprocess communication with the general-purpose printer driver 16. As can be seen from the acquisition from the general-purpose printer driver 16, the equipment information is equipment information that can be acquired by the general-purpose printer driver 16. Specifically, the general-purpose printer driver 16 can acquire the equipment information on the printer A (31) from the printer A (31) using a general-purpose protocol such as an IPP.

In the determination processing, the necessity of updating the application A (18), which is an external program related to the printer A (31), is determined based on the equipment information acquired in the acquisition processing. For example, in the determination processing, first, information on the application A (18) associated with the equipment information is obtained. Next, in the determination processing, a version of the application A (18) is checked, and the latest version of the application A (18) provided by the download server 20 is checked, and the two versions are compared with each other to determine whether the update is necessary. Whether the update is necessary may mean, for example, whether the latest version of the application A (18) in the storage unit 12 is present in the download server 20.

In the update processing, when it is determined in the determination processing that the update of the application A (18) is necessary, the application A (18) is updated. The update of the application A (18) may mean version upgrade of the application A (18). In the update processing, the application A (18) is updated by downloading an update program of the application A (18) from the download server 20 and executing the update program. In the update processing, the application A (18) may be updated by executing the update program of the application A (18) on the download server 20.

In other words, the embodiment can provide an update method including the acquisition processing, the determination processing, and the update processing described above.

Further, in other words, the terminal apparatus 10 includes the general-purpose printer driver 16, and an acquisition processing unit, a determination processing unit, and an update processing unit described below. The acquisition processing unit acquires the apparatus information on the printer A (31) from the general-purpose printer driver 16. The determination processing unit determines, based on the equipment information acquired by the acquisition processing unit, the necessity of updating the application A (18) which is an external program related to the printer A (31). When the determination processing unit determines that the update of the application A (18) is necessary, the update processing unit updates the application A (18).

### Effects of Embodiment 1

Prior to describing a more specific example of the update processing according to the embodiment, effects of the embodiment will be described.

As described above, the printing system 100 can automatically update the application A (18) provided by the vendor of the printer in an environment where printing processing is performed using the general-purpose printer driver 16 such as an OS standard printer driver. Therefore, in the printing system 100, it is not required to manually update the application A (18) by the user even in such an environment, the time and effort of the update can be reduced, and the update can be easily performed.

As described above, according to the embodiment, it is possible to easily update an application program related to a printer, which is provided by a vendor of a printer, for example, in an environment where the printing processing is performed using the general-purpose printer driver 16.

In order to supplement such effects, the embodiment is compared with printing systems according to Comparative Examples 1 and 2. First, the printing system according to Comparative Example 1 is a system that performs printing processing using a printer driver specific to a vendor of a printer, not a general-purpose printer driver such as an IPP Class driver incorporated as a standard in an OS. In this case, the terminal apparatus updates the application program using an update program for managing the update of the application program provided by the vendor. The update program compares a version of an application program installed in the terminal apparatus with a version of an application program published by the download server, and executes the version upgrade as necessary. However, the printing system according to Comparative Example 1 cannot perform the printing processing using the general-purpose printer driver.

The printing system according to Comparative Example 2 is a system that performs printing processing using a general-purpose printer driver such as an IPP Class driver. However, the terminal apparatus according to Comparative Example 2 does not include the printing control program according to the embodiment. In the printing system according to Comparative Example 2, the printing processing is performed using the general-purpose printer driver, and therefore, the update program used in Comparative Example 1 cannot be used. Therefore, in the printing system according to Comparative Example 2, which application program the printer supports cannot be determined, and the application program cannot be updated.

On the other hand, as described above, in the embodiment, the printing control program described above can be introduced, and thus, it is possible to determine which application program the printer supports and to update the determined application program. Therefore, according to the printing system 100 in the embodiment, the following effects are achieved even in an environment where printing processing is performed using the general-purpose printer driver 16 such as an IPP Class driver. That is, according to the printing system 100 in the embodiment, it is possible to easily update, for example, the application program related to the printer provided by the vendor of the printer, and to keep the application program in the latest state normally.

### First Example of Update Processing

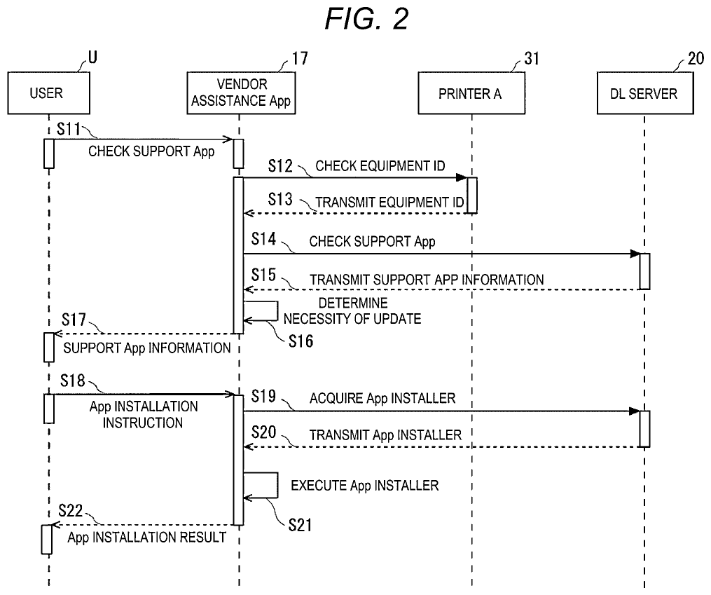

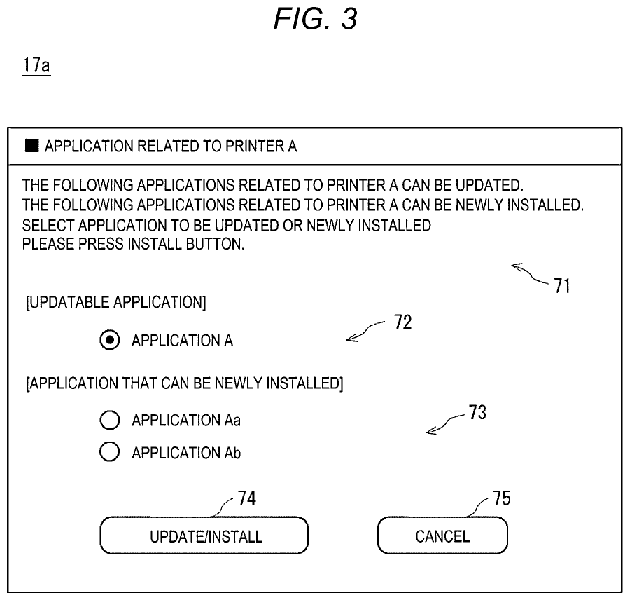

A first example of the update processing will be described with reference to FIGS. 2 and 3. FIG. 2 is a sequence diagram illustrating the first example of the update processing in the printing system 100 shown in FIG. 1. FIG. 3 is a diagram showing an example of a UI image displayed by the vendor assistance App 17 in the update processing shown in FIG. 2.

In the first example, an example in which only the printer A (31) is connected to the terminal apparatus 10, and only the application A (18) among the application programs installed in the terminal apparatus 10 is supported by the printer A (31) is described.

In the first example, first, a user U performs an operation of starting the vendor assistance App 17 using the operation unit 14, and performs a check instruction operation for checking, by the vendor assistance App 17, the application program supported by the printer A (31) (step S11). Even if the user U does not perform the check instruction operation, the vendor assistance App 17 may be configured to perform the above-described check at a time point of starting.

The vendor assistance App 17 that received the check instruction transmits, via the general-purpose printer driver 16, a request to check an equipment ID as an example of the equipment information to the printer A (31) connected to the terminal apparatus 10 (step S12). The equipment ID may be referred to as an apparatus ID or a device ID. Then, the printer A (31) transmits the equipment ID of the printer A (31) to the general-purpose printer driver 16 as a response, and the general-purpose printer driver 16 transmits the equipment ID to the vendor assistance App 17 (step S13). In the sequence diagrams such as FIG. 2, the illustration of the general-purpose printer driver 16 is omitted. The interprocess communication is performed between the general-purpose printer driver 16 and the vendor assistance App 17. The IPP communication is performed between the general-purpose printer driver 16 and the printer A (31).

For example, the general-purpose printer driver 16 can acquire the equipment ID from attribute information that indicates an attribute of the printer A (31) and is set for the printer A (31) by the general-purpose printer driver 16. In step S12, the general-purpose printer driver 16 requests attribute information for such setting, and in step S13, the general-purpose printer driver 16 can acquire the equipment ID from the printer A (31) as a part of the attribute information. The vendor assistance App 17 can transmit the request to check the equipment ID and receive the equipment ID through the processing performed by the general-purpose printer driver 16.

The attribute information can be information indicating a capability and a state of the printer A (31). For example, when the general-purpose printer driver 16 is an IPP Class driver, the attribute information may be the following information. That is, in this case, the attribute information may refer to, for example, any one of Printer Attribute, Enable Printer, and Printer Description Attribute set as a setting value of the IPP. When the general-purpose printer driver 16 already acquired the attribute information, it is not necessary to transmit the check request in step S12 to the printer A (31), and the vendor assistance App 17 may acquire the attribute information from the general-purpose printer driver 16 in step S13.

As described above, in the acquisition processing, the equipment ID of the printer A (31) may be acquired from the attribute information on the printer A (31) set by the general-purpose printer driver 16.

Next, the vendor assistance App 17 transmits a request to check the application program supported by the printer A (31) having the acquired equipment ID, to the download server 20 with the URL stored in advance (step S14). The term URL is an abbreviation of “Uniform Resource Locator”. Then, the download server 20 transmits, as a response, information indicating the application program supported by the printer A (31) to the vendor assistance App 17 (step S15). In FIG. 2, the application program is simply abbreviated as “App” due to space limitations. Hereinafter, the information transmitted in step S15 is referred to as support App information. Accordingly, the vendor assistance App 17 can acquire the support App information. The acquired support App information may be information indicating the latest version of the application program supported by the printer A (31).

Next, the vendor assistance App 17 determines, based on the support App information received from the download server 20, whether the application program indicated by the support App information is installed. In this example, the application A (18) is installed. Then, the vendor assistance App 17 compares a version of the determined installed application A (18) with the latest version indicated by the support App information to determine the necessity of updating the application A (18) (step S16).

Next, the vendor assistance App 17 incorporates the acquired support App information and the determination result of the necessity of update into a UI image of the vendor assistance App 17 and displays the UI image, and the user U checks the UI image (step S17). When the determination result in step S16 indicates that the update is not required, the vendor assistance App 17 may not execute the processing in step S17 and the subsequent steps or the processing in step S18 and the subsequent steps described below. When the determination result in step S16 indicates that the update is not required and the UI image such as a UI image 17a is displayed, the UI image only needs to include, for example, a sentence indicating that no application program needs to be updated.

The UI image displayed in step S17 may be, for example, a UI image that indicates an updatable application program such as the UI image 17a shown in FIG. 3 and can instruct the execution of the update.

The UI image 17a is exemplified by a UI image in which not only an updatable application program can be updated but also a newly installable application program can be newly installed. This is because the support App information can include not only the installed application A (18) but also all the information on the application program supported by the printer A (31).

The UI image 17a can include a sentence 71 for description, an update target group 72 in which a radio button for selection is attached to each target, a new installation target group 73 in which a radio button for selection is attached to each target, an update/install button 74, and a cancel button 75.

As shown, the sentence 71 can include, for example, a sentence indicating that the update target group 72, which is an installed application program related to the printer A (31), can be updated. In addition, the sentence 71 can include a sentence indicating that the new installation target group 73, which is a non-installed application program related to the printer A (31), can be installed. In this example, the update target group 72 includes only the application A (18). FIG. 3 shows an example in which an application Aa and an application Ab are included in the new installation target group 73. Of course, the sentence 71 may be a sentence that recommends update or new installation.

In the example in which the new installation is proposed as illustrated in the UI image 17a, the determination processing in step S16 includes the determination of the necessity of the new installation. The vendor assistance App 17 may compare the application program installed in the terminal apparatus 10 with the support App information. Accordingly, the vendor assistance App 17 can obtain information indicating an application program that is not installed among the application programs related to the printer A (31).

The user U selects a target application program by selecting a radio button corresponding to an application program that is required to be updated or newly installed, and performs an installation instruction by selecting the update/install button 74 (step S18). The installation instruction is given to the vendor assistance App 17. The update may also correspond to installation of a new version, and therefore, an update instruction is described as an installation instruction in step S18. In the example of the UI image 17a, only the update of the application A (18) is selected, and therefore, the update instruction of the application A (18) is given as the installation instruction.

The vendor assistance App 17 that received the installation instruction transmits, to the download server 20, a transmission request for acquiring an App installer that is an update program of the target application program (step S19). When the download server 20 that received the transmission request transmits the target App installer, the vendor assistance App 17 completes the download (step S20).

Next, the vendor assistance App 17 executes the App installer to update or newly install the target application program (step S21). In the example of the UI image 17a, only the update of the application A (18) is selected, and therefore, only the App installer of the application A (18) is downloaded in step S20, and only the App installer thereof is executed in step S21.

When the update or the new installation is completed, the vendor assistance App 17 or the App installer may display an installation result indicating that the update or the new installation is completed to the user U, and the user U may check the result (step S22). The update and new installation may fail, and in this case, an installation result indicating failure may be displayed. As described above, from the execution of the App installer to the completion or failure of the update or the new installation, the vendor assistance App 17 or the App installer can receive an instruction from the user U as necessary and proceed with the processing in accordance with the instruction.

On the other hand, when the user U does not want to update any application program or newly install any application program, the user U may select the cancel button 75, instead of step S18. The vendor assistance App 17 that received the selection may close the UI image 17a without performing the update or the new installation.

As described in the first example, when it is determined in the determination processing that the update of the application A (18) is required, the application A (18) determined to be required can be updated in the update processing described above.

As in the example in which the processing in steps S17 and S18 are performed, in the update processing described above, when it is determined in the determination processing that the update or the new installation of the application program is required, the update or the new installation may be executed after the user U checks the update or the new installation. That is, in the update processing described above, when the user U instructs the update or the new installation, the update or the new installation of the application program may be executed. However, such check of the update or the new installation for user U is not essential. That is, when it is determined that the update or the new installation is required, the update or the new installation may be automatically executed.

The UI image 17a is displayed in step S17, and the following UI image may be displayed instead of the UI image 17a. That is, the vendor assistance App 17 may extract only the installed application A (18) from pieces of information indicated by the support App information and display a UI image including only the update of the extracted application A (18). As described above, the vendor assistance App 17 may support only to the update without supporting the new installation.

In the example shown in FIG. 2, the vendor assistance App 17 performs all the determination processing. Alternatively, the following processing may be adopted instead. That is, the download server 20 may perform determination of the necessity, transmit the determination result as the support App information to the vendor assistance App 17, and the vendor assistance App 17 may use the determination result in the download server 20 as it is as a determination result. In this case, in step S14, the vendor assistance App 17 determines by itself whether the application program supported by the printer A (31) indicated by the equipment ID acquired in step S13 is installed. Then, in step S14, the vendor assistance App 17 also transmits information indicating the installed application program, the information indicating the application A (18) in this example, to the download server 20. Accordingly, the download server 20 can determine whether the update is required.

In the first example of the update processing, the equipment ID can be easily acquired by acquiring the equipment ID using the attribute information. In addition, in the above-described first example, by supporting the new installation, the terminal apparatus 10 can be caused to execute installation of a non-installed application program related to the printer A (31). In addition, in the above first example, the processing can be performed according to the intention of the user U by executing update of the application program or the like after the user U performs check.

### Second Example of Update Processing

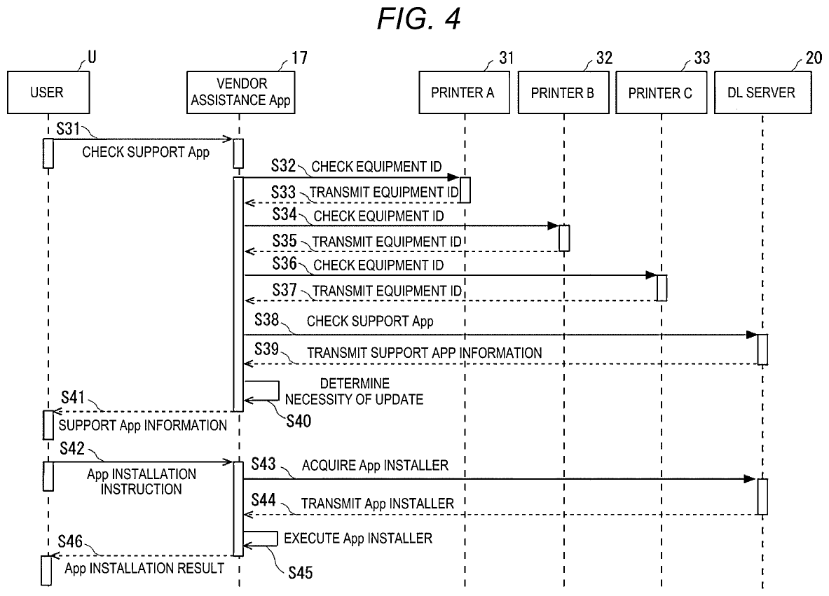

A second example of the update processing will be described with reference to FIG. 4. FIG. 4 is a sequence diagram illustrating a second example of the update processing in the printing system 100 shown in FIG. 1.

The second example is an example in which the first example is adapted to handle updates or the like on application programs related to a plurality of printers. In the second example, the application A (18) is an application program related to the printer A (31), and although not shown, application programs respectively related to the printer B (32) and the printer C (33) are also stored in the storage unit 12.

In the second example, the processing in steps S11 to S13 of the first example is also applied (steps S31 to S33). Next, the vendor assistance App 17 transmits a request to check an equipment ID to the printer B (32) in the same way as to the printer A (31) (step S34), and receives the equipment ID transmitted from the printer B (32) (step S35). Next, the vendor assistance App 17 transmits a request to check an equipment ID to the printer C (33) in the same way as to the printer A (31) (step S36), and receives the equipment ID transmitted from the printer C (33) (step S37). As described above, the vendor assistance App 17 can acquire the equipment IDs of the printer A (31), the printer B (32), and the printer C (33). Note that the order of printers from which equipment IDs are acquired does not matter, and specific rules such as an order in which printers are registered in the general-purpose printer driver 16 may be determined in advance.

As described above, the acquisition processing described above may be processing of acquiring equipment information from the general-purpose printer driver 16 for each of a plurality of printers.

Next, as in step S14 shown in FIG. 2, the vendor assistance App 17 transmits a request to check an application program supported by a printer having the acquired equipment ID to the download server 20 with the URL stored in advance (step S38). However, in step S38, unlike step S14, a request to check application programs supported by all of the printers having the acquired equipment IDs, the printer A (31), the printer B (32), and the printer C (33) is transmitted.

Then, the download server 20 transmits, as a response, information indicating the application programs supported by the printer A (31), the printer B (32), and the printer C (33) to the vendor assistance App 17 (step S39). Accordingly, the vendor assistance App 17 can acquire, as support App information, information indicating the latest versions of the application programs supported by the printer A (31), the printer B (32), and the printer C (33). Of course, an application program related to the printer A (31) and an application program related to another printer B (32) or printer C (33) may duplicate. For example, the application A (18) may be related to the printer A (31), and may also be related to the printer B (32). Therefore, the download server 20 may transmit the support App information to the vendor assistance App 17 so as to avoid duplication of the information. However, the vendor assistance App 17 may determine duplication of information, keep one of the duplicate pieces of information, and use the one for subsequent processing.

Next, the vendor assistance App 17 determines, based on the support App information received from the download server 20, whether the application program indicated by the support App information is installed. In this example, in order to simplify the description, it is assumed that the application A (18) is also installed. Then, as in step S16, the vendor assistance App 17 compares a version of the determined installed application A (18) with the latest version indicated by the support App information. By performing such a comparison, the vendor assistance App 17 determines the necessity of updating the application A (18) (step S40).

Next, as in step S17, the vendor assistance App 17 incorporates the acquired support App information and the determination result of the necessity of update into a UI image of the vendor assistance App 17 and displays the UI image, and the user U checks the UI image (step S41). For example, the mark “printer A” in the UI image 17a shown in FIG. 3 may be changed to “registered printer” or “printer A, printer B, and printer C” in the UI image to be displayed here.

Although the description of the processing subsequent to step S41 is omitted, the processing is the same as steps S18 to S22 shown in FIG. 2 (steps S42 to S46) and is the same when the user U does not want to update any application program or newly install any application program.

In the second example of the update processing, in addition to the effect of the first example, an effect that update or new installation can be performed for the application program related to each of a plurality of printers is exhibited. The above-described second example also has an advantage in that the processing can be performed at once compared with the example in which the first example of the update processing is repeated for each printer.

### Third Example of Update Processing

A third example of the update processing will be described. In the first example, the application A (18) or the like is updated when the user U starts the vendor assistance App 17. On the other hand, in the third example, the user U starts an application program for performing starting, editing, or the like of a printing target file such as a document file, and performs a printing setting or a printing instruction for the printer A (31) to update the application A (18) and the like.

Specifically, first, the user U starts an application program for performing starting, editing, or the like of a printing target file such as a document file. Here, the application program to be started may be the application A (18) that is determined to be related to the printer A (31) or any other application programs, as long as it is an application program that enables printing.

Next, the user U performs, by the operation unit 14, an operation of selecting the printer A (31) in the printing setting of the printing target file or an operation of giving a printing instruction to the printer A (31). In the third example, such an operation is treated as the check instruction operation in step S11 shown in FIG. 2 to perform processing. With the operation, the vendor assistance App 17 is started via the general-purpose printer driver 16, and the processing shown in FIG. 2 can be executed.

With the operation of giving the printing instruction to the printer A (31), the general-purpose printer driver 16 converts the printing target file into printing data that is data in a printable format, and the vendor assistance App 17 receives the printing data from the general-purpose printer driver 16. Therefore, the determination processing in the third example means determination of the necessity of updating the application program related to the printer A (31) when the printing data that is data to be processed by the printer is received from the general-purpose printer driver 16.

In addition, the general-purpose printer driver 16 starts the vendor assistance App 17 by the operation of performing the printing setting of the printer A (31). Therefore, the determination processing in the third example may also mean determination of the necessity of update when the vendor assistance App 17 is started by specifying the printer A (31) by the general-purpose printer driver 16. The determination target here is an application program related to the printer A (31).

Of course, the third example can be applied not only to the update of an application program but also to the new installation. Also in the third example, in the situation described in steps S17 and S18 in the first example, the update may be executed after the check by the user U, or the update may be automatically executed without the check by the user U.

In the third example of the update processing, in addition to the effect of the first example, effects that the time and effort of the check by the user U can be further reduced and the update or the new installation of the application program related to the printer can be executed are exhibited. Of course, the third example can be similarly applied to the second example.

### Embodiment 2

### System Configuration

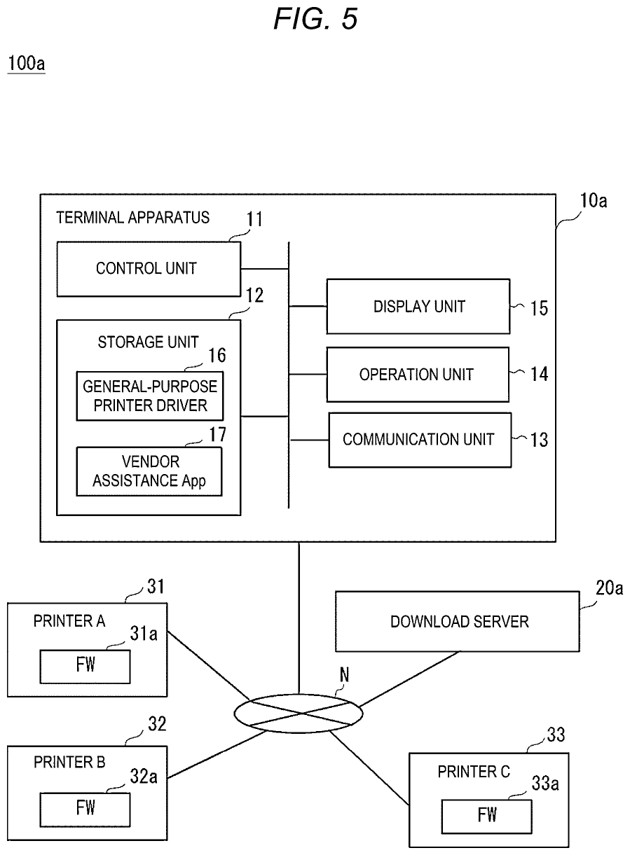

A configuration example of a printing system according to Embodiment 2 will be described with reference to FIG. 5. FIG. 5 is a block diagram showing the configuration example of the printing system according to Embodiment 2.

As shown in FIG. 5, a printing system 100a according to the embodiment is a system in which a firmware program stored in each printer is a target of update or the like in the printing system 100 shown in FIG. 1. That is, the application program is described as an example of the external program that is a target of update or the like in Embodiment 1, and in the embodiment, the external program that is a target of update or the like is a firmware program of a printer. The firmware program of the printer is basically provided by the vendor of the printer.

In FIG. 5, the firmware programs stored in the printer A (31), the printer B (32), and the printer C (33) are a FW 31a, a FW 32a, and a FW 33a, respectively. In the printing system 100a, the terminal apparatus 10a will be described as an example in which the application A (18) is not installed in the terminal apparatus 10.

The download server 20a in the embodiment is a server that stores the following update program instead of the update program of the application program in the download server 20. The update program is a program for updating firmware programs of various printers, such as the FW 31a, the FW 32a, and the FW 33a. The update program is stored in a state where the update program can be downloaded by each printer so as to be provided to each printer, or is stored in a state where the update program can be downloaded by the terminal apparatus 10a so as to be provided to the terminal apparatus 10a. The download server 20a can also store the firmware programs for various printers. As described above, the download server 20a may be a server that collectively manages and discloses a plurality of firmware programs provided by the vendor of the printer. Other configurations and processing of the printing system 100a are the same as those of the printing system 100, and the description thereof is omitted.

In the printing control program according to the embodiment, processing targets in the determination processing and the update processing are firmware programs such as the FW 31a, the FW 32a, and the FW 33a. Therefore, in the update processing according to the embodiment, for example, when it is determined in the determination processing that the FW 31a is required to be updated, the FW 31a is updated. With such a configuration, the printing system 100a updates the firmware program of the printer similarly to the application program stored in the printing system 100.

### Effects of Embodiment 2

Prior to describing a more specific example of the update processing according to the embodiment, effects of the embodiment will be described.

As can be seen from the above description, the printing system 100a can automatically update the firmware program provided by the vendor of the printer in an environment where printing processing is performed using the general-purpose printer driver 16 such as an OS standard printer driver. Therefore, in the printing system 100a, it is not required to manually update the firmware program by the user even in such an environment, the time and effort of the update can be reduced, and the update can be easily performed.

As described above, according to the embodiment, it is possible to easily update the firmware program of the printer, which is provided by the vendor of the printer, for example, in an environment where the printing processing is performed using the general-purpose printer driver 16.

In order to supplement such effects, the embodiment is compared with printing systems according to Comparative Examples 3 and 4. First, as in Comparative Example 1, the printing system according to Comparative Example 3 is a system that performs printing processing using a printer driver specific to a vendor of a printer, not a general-purpose printer driver such as an IPP Class driver incorporated as a standard in an OS. In this case, the terminal apparatus updates the firmware program using an update program for managing the update of the firmware program. The update program compares a v version of firmware program of the printer set in the terminal apparatus as a printer capable of performing printing with a version of a firmware program published in the download server. Then, after executing the comparison, the update program executes the version upgrade as necessary. However, the printing system according to Comparative Example 2 cannot perform the printing processing using the general-purpose printer driver.

The printing system according to Comparative Example 4 is a system that performs printing processing using a general-purpose printer driver such as an IPP Class driver as in Comparative Example 2. However, the terminal apparatus according to Comparative Example 4 does not include the printing control program according to the embodiment as in Comparative Example 2. In the printing system according to Comparative Example 4, the printing processing is performed using the general-purpose printer driver, and therefore, the update program used in Comparative Example 3 cannot be used. Therefore, in the printing system according to Comparative Example 4, whether the firmware program of the printer is the latest one cannot be determined, and the firmware program cannot be updated either.

On the other hand, as described above, in the embodiment, the printing control program described above is introduced to determine whether the firmware program of the printer is required to be updated according to whether the firmware program of the printer is the latest one, or the like, and the update can be executed if necessary. Therefore, according to the printing system 100a in the embodiment, the following effects are achieved even in an environment where printing processing is performed using the general-purpose printer driver 16 such as an IPP Class driver. That is, according to the printing system 100a in the embodiment, it is possible to easily update the firmware program of the printer and to normally keep the firmware program in the latest state.

### Fourth Example of Update Processing

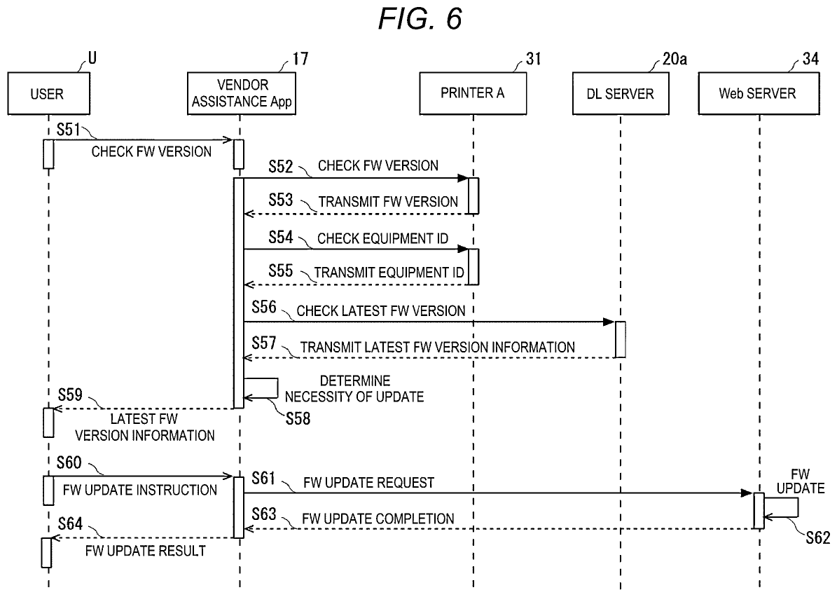

A fourth example of the update processing will be described with reference to FIG. 6. The fourth example corresponds to the first example of the update processing according to Embodiment 2. FIG. 6 is a sequence diagram illustrating the fourth example of the update processing in the printing system, which is the first example of the update processing in the printing system 100a shown in FIG. 5.

In the fourth example, for simplification of description, an example in which only the printer A (31) is connected to the terminal apparatus 10a will be described.

In the third example, first, the user U performs an operation of starting the vendor assistance App 17 using the operation unit 14, and the vendor assistance App 17 performs a check instruction operation for checking a version of the FW 31a of the printer A (31) (step S51). Even if the user U does not perform the check instruction operation, the vendor assistance App 17 may be configured to perform the above-described check at a time point of the starting.

The vendor assistance App 17 that received the check instruction transmits a request to check the version of the FW 31a to the printer A (31) connected to the terminal apparatus 10a (step S52). Then, the printer A (31) transmits FW version information, which is information indicating the version of the FW 31a, to the vendor assistance App 17 as a response (step S53).

The communication in steps S52 and S53 may be executed in accordance with, for example, a protocol that is a vendor extension of IPP, or another protocol such as Simple Network Management Protocol (SNMP) or a vendor-specific protocol. Note that the processing in steps S52 and S53 may be executed after the processing in steps S54 and S55 described below, or after the processing in steps S56 and S57, or before step S58.

Thereafter, as in step S12 shown in FIG. 2, the vendor assistance App 17 transmits, via the general-purpose printer driver 16, a request to check an equipment ID as an example of equipment information to the printer A (31) connected to the terminal apparatus 10a (step S54). Then, as in step S13 shown in FIG. 2, the printer A (31) transmits the equipment ID of the printer A (31) to the general-purpose printer driver 16 as a response, and the general-purpose printer driver 16 transmits the equipment ID to the vendor assistance App 17 (step S55).

Next, the vendor assistance App 17 transmits a request to check the latest version of the FW 31a of the printer A (31) having the acquired equipment ID to the download server 20a with the URL stored in advance (step S56). Then, the download server 20 transmits the latest FW version information, which is information indicating the latest version of the FW 31a, to the vendor assistance App 17 as a response (step S57). Accordingly, the vendor assistance App 17 can acquire the latest FW version information.

Next, the vendor assistance App 17 compares the latest FW version information received from the download server 20a with the FW version information received from the printer A (31), and determines whether both the version information match. As described above, the vendor assistance App 17 determines whether the FW 31a is the latest version, that is, whether the update of the FW 31a is required (step S58).

Next, the vendor assistance App 17 incorporates the acquired latest FW version information and the determination result of the necessity of update into a UI image of the vendor assistance App 17 and displays the UI image, and the user U checks the UI image (step S59). Although not illustrated, the UI image may include, for example, a button for performing the update when the update is required, and may include a sentence indicating the latest version when the update is not required. When the determination result in step S58 indicates that the update is not required, the vendor assistance App 17 may not execute the processing in step S59 and subsequent steps or the processing in step S60 and subsequent steps described below.

The user U gives an update instruction of the target FW 31a by selecting, by the operation unit 14, the button for performing the update in the UI image displayed in step S59 (step S60). The FW update instruction as the update instruction is given to the vendor assistance App 17.

The vendor assistance App 17 that received the FW update instruction transmits a FW update request, which is an update request for the FW 31a, to the Web server 34 (step S61). The Web server 34 is a server provided in the printer A (31). Note that the Web server 34 may also be installed as a server outside the printer A (31), and may be connected to the printer A (31) via a network in this case.

For the transmission in step S61, the terminal apparatus 10a may include a Web browser serving as a client of the Web server 34 in the vendor assistance App 17 or outside the vendor assistance App 17. Then, the vendor assistance App 17 that received the FW update instruction may transmit the FW update request by starting the Web browser and accessing a preset IP address serving as the internet protocol (IP) address of the Web server 34.

The Web server 34 that received the FW update request requests the download server 20a to transmit command data for executing update of the FW 31a, and the download server 20a transmits the command data to the Web server 34 as a response. Note that the update of the FW 31a may mean rewriting of the FW 31a. The command data can be referred to as read-only memory (ROM) data. Accordingly, the Web server 34 can receive the command data for the FW 31a. By executing the command data, the Web server 34 controls the printer A (31) to execute the update of the FW 31a, that is, version upgrade of the FW 31a (step S62).

When the update is completed, the Web server 34 transmits an FW update completion notification indicating that the update is completed to the vendor assistance App 17 (step S63). Accordingly, the vendor assistance App 17 receives the notification and displays, on the UI image, an FW update result indicating an update result of the FW (step S64). When the update failed, a notification of the FW update failure may be given in step S63, and a notification of the failure may be sent as an FW update result in step S64.

On the other hand, when the user U does not want to update the FW 31a, instead of step S60, the user U may instruct the vendor assistance App 17 not to update the FW 31a.

As described in the fourth example, in the update processing according to the embodiment, when it is determined in the determination processing that the FW 31a is required to be updated, the FW 31a determined to be required to be updated can be updated.

As in the example in which the processing in steps S59 and S60 is performed, in the update processing described above, when it is determined in the determination processing that the firmware program is required to be updated, the update may be executed after the user U performs the check. That is, in the update processing described above, when the user U gives an update instruction, the update of the firmware program may be executed. However, such a check of the update by the user U is not essential. That is, the update may be automatically executed when it is determined that the update is required.

In the example shown in FIG. 6, the vendor assistance App 17 performs all the determination processing. Alternatively, the following processing may be adopted instead. That is, the download server 20a may perform determination of the necessity, transmit the determination result as the latest FW version information to the vendor assistance App 17, and the vendor assistance App 17 may use the determination result in the download server 20a as it is as a determination result. In this case, in step S56, the vendor assistance 17 App transmits information indicating the version of the firmware program, that is, FW version information of the FW 31a in this example, to the download server 20a. Then, the download server 20a may determine the necessity of the update using the FW version information, and transmit the determination result as the latest FW version information in step S57.

In step S61, the vendor assistance App 17 may transmit a transmission request to acquire command data for executing update of the target FW 31a to the download server 20a. In this case, in step S62, the download server 20a that received the transmission request transmits the target command data to the vendor assistance App 17, so that the vendor assistance App 17 completes the download. Then, by executing the command data, the vendor assistance App 17 may control the printer A (31) to complete the version upgrade of the FW 31a.

In the fourth example of the update processing, the version upgrade of the firmware program of the printer can be easily completed instead of the application program in the first example of the update processing according to Embodiment 1. In the above-described fourth example, the update of the firmware program with the latest version can also be executed using a Web server provided in the printer. In addition, in the above-described fourth example, the processing can be performed according to the intention of the user U by executing the update of the firmware program after the user U performs the check.

### Fifth Example of Update Processing

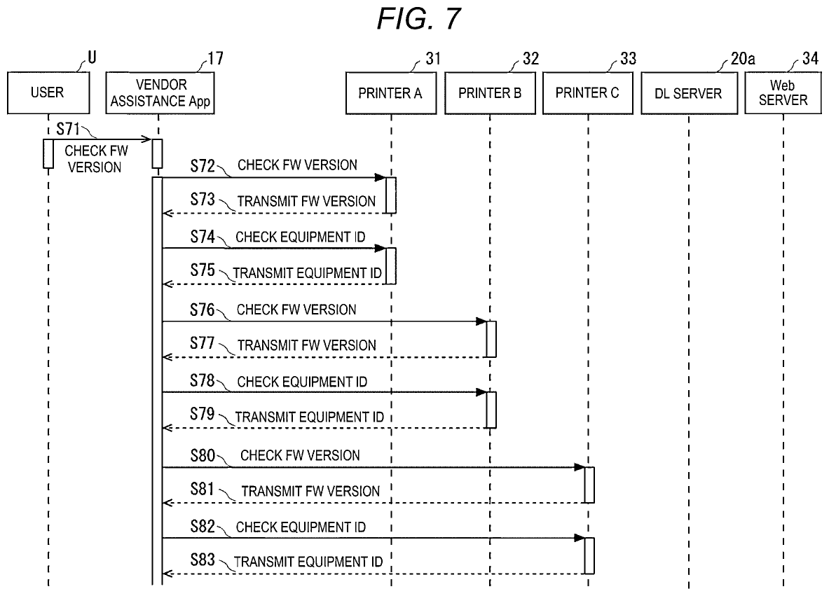

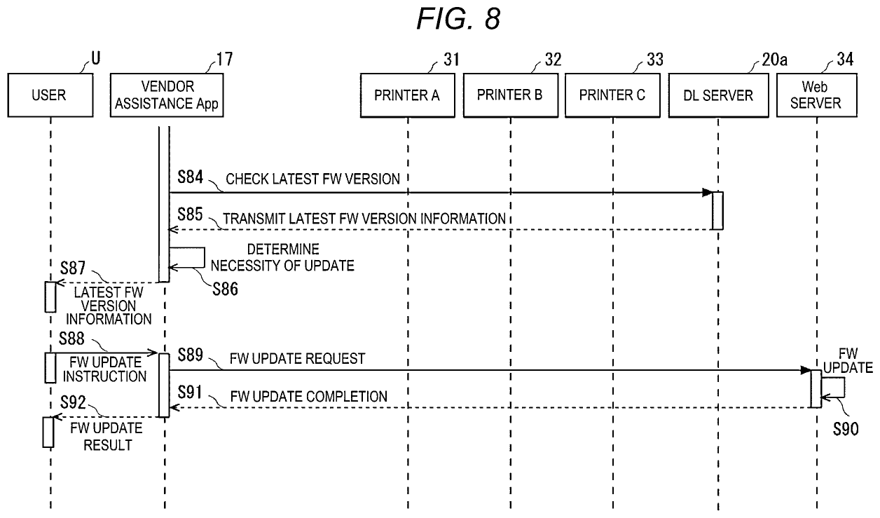

A fifth example of the update processing will be described with reference to FIGS. 7 and 8. The fifth example corresponds to a second example of the update processing according to Embodiment 2. FIG. 7 is a sequence diagram illustrating the fourth example of the update processing in the printing system, which is the second example of the update processing in the printing system 100a shown in FIG. 5. FIG. 8 is a sequence diagram continuing from FIG. 7.

The fifth example is an example in which the fourth example is adapted to handle updates on the FW 31a, the FW 32a, and the FW 33a, which are firmware programs of the printer A (31), the printer B (32), and the printer C (33) as examples of the plurality of printers.

In the fifth example, the processing in steps S51 to S55 of the fourth example is also applied (steps S71 to S75). Next, the vendor assistance App 17 also transmits a request to check FW version information to the printer B (32) (step S76) and receives a response (step S77) in the same way as to the printer A (31). In addition, the vendor assistance App 17 also transmits a request to check an equipment ID to the printer B (32) (step S78) and receives the equipment ID as a response (step S79) in the same way as to the printer A (31). Accordingly, the vendor assistance App 17 can acquire the FW version information and the equipment ID of the printer B (32). Next, the vendor assistance App 17 also transmits a request to check FW version information to the printer C (33) (step S80) and receives a response (step S81) in the same way as to the printer A (31). In addition, the vendor assistance App 17 also transmits a request to check an equipment ID to the printer C (33) (step S82) and receives the equipment ID as a response (step S83) in the same way as to the printer A (31). Accordingly, the vendor assistance App 17 can acquire the FW version information and the equipment ID of the printer C (33). Note that the order of printers from which the FW version information and the equipment IDs are acquired does not matter, and specific rules such as an order in which printers are registered in the general-purpose printer driver 16 may be determined in advance.

As described above, the acquisition processing in the embodiment may also be processing of acquiring equipment information from the general-purpose printer driver 16 for each of the plurality of printers.

Next, as in step S56 shown in FIG. 6, the vendor assistance App 17 transmits a request to check the latest version of a firmware program of each printer indicated by the acquired equipment ID to the download server 20a with the URL stored in advance (step S84). However, in step S84, unlike step S56, a request to check the respective latest versions of the FW 31a, the FW 32a, and the FW 33a for the printer A (31), the printer B (32), and the printer C (33) indicated by the acquired equipment IDs is transmitted.

Then, the download server 20a transmits latest FW version information, which is information indicating the latest versions of the FW 31a, the FW 32a, and the FW 33a, to the vendor assistance App 17 as a response (step S85). Accordingly, the vendor assistance App 17 can acquire the latest FW version information on the FW 31a, the FW 32a, and the FW 33a.

Next, the vendor assistance App 17 compares the latest FW version information received from the download server 20a with the FW version information received from each printer, and determines, for each printer, whether both the version information match. Accordingly, the vendor assistance App 17 determines whether each of the FW 31a, the FW 32a, and the FW 33a is the latest version (step S86). The determination in step S86 means determination of the necessity of updating each of the FW 31a, the FW 32a, and the FW 33a.

Next, as in step S59, the vendor assistance App 17 incorporates the acquired latest version information and the determination result of the necessity of update into a UI image of the vendor assistance App 17 and displays the UI image, and the user U checks the UI image (step S87). The UI image displayed here is a UI image indicating determination results for all of the printer A (31), the printer B (32), and the printer C (33) in the UI image displayed in the fourth example. Although not illustrated, the UI image may include, for example, a button for performing the update when the update is required, and may include a sentence indicating the latest version when the update is not required. When the determination result in step S86 indicates that update is not required, the vendor assistance App 17 may not execute, for any firmware program, the processing in step S87 and the subsequent steps or the processing in step S88 and the subsequent steps described below.

The user U gives an update instruction of a firmware program as an update target among the FW 31a, the FW 32a, and the FW 33a by selecting, by the operation unit 14, a button for performing the update in the UI image displayed in step S87 (step S88). The FW update instruction as the update instruction is given to the vendor assistance App 17.

The vendor assistance App 17 that received the FW update instruction transmits a FW update request, which is a request to update the firmware program as an update target, to the Web server 34 as in step S61 (step S89). The illustrated Web server 34 is a server provided in the printer A (31), a server provided in the printer B (32), and a server provided in the printer C (33). In step S89, a FW update request is transmitted to each of the servers provided in the printers as update targets.

For the transmission in step S89, the terminal apparatus 10a may include a Web browser serving as a client of the Web server 34 in the vendor assistance App 17 or outside the vendor assistance App 17. Then, the vendor assistance App 17 that received the FW update instruction may transmit the FW update request to each Web server 34 by starting the Web browser and accessing a preset IP address serving as an IP address of each Web server 34.

Each Web server 34 that received the FW update request requests the download server 20a to transmit command data for executing update of the target firmware program, and the download server 20a transmits the command data to the Web server 34 as a response. Accordingly, each Web server 34 can receive the command data for the target firmware program. By executing the command data, the Web server 34 executes the update, that is, version upgrade of the firmware program as an update target by controlling the target printer (step S90). Accordingly, for example, when all of the FW 31a, the FW 32a, and the FW 33a are update targets, any firmware program may be updated.

The Web server 34 may also be installed as a common server outside the printer A (31), the printer B (32), and the printer C (33). In this case, the Web server 34 may be connected to the printer A (31), the printer B (32), and the printer C (33) via a network. In this case, a transmission destination of the FW update request in step S89 is one Web server 34. Then, the Web server 34 acquires, from the download server 20a, command data of one or a plurality of printers whose firmware programs are update targets. Depending on the model of each printer, a plurality of firmware programs out of the FW 31a, the FW 32a, and the FW 33a may be the same. In this case, only one common command data may be acquired. Then, the Web server 34 executes the acquired command data to control a printer as a firmware update target to perform processing of updating the firmware program. As described above, when a common server is provided as the Web server 34, any firmware program may also be updated, for example, when all of the FW 31a, the FW 32a, and the FW 33a are update targets.

When the update is completed, each Web server 34 that received the FW update request transmits an FW update completion notification indicating that the update is completed to the vendor assistance App 17 (step S91). Accordingly, the vendor assistance App 17 receives the notification and displays, on the UI image, an FW update result indicating the update result of each FW (step S92). For the firmware program that was failed to update, a notification of the FW update failure may be given in step S91, and a notification of the failure may be sent as an FW update result in step S92.

On the other hand, when the user U does not want to update any firmware program, instead of step S88, the user U may instruct the vendor assistance App 17 not to execute the update.

In the fifth example of the update processing, in addition to the effect of the fourth example, an effect that updates on the firmware programs of a plurality of printers can be collectively executed is exhibited. That is, the above-described fifth example has an advantage in that the processing can be performed at once compared to the example in which the fourth example of the update processing is repeated for each printer.

### Sixth Example of Update Processing

A sixth example of the update processing will be described. The sixth example corresponds to a third example according to Embodiment 2. In the sixth example, the third example of the update processing described in Embodiment 1 is applied to Embodiment 2 in the same manner.

The sixth example of the update processing will be described. In the fourth example, the FW 31a is updated when the user U starts the vendor assistance App 17. On the other hand, in the sixth example, the user U starts an application program for performing starting, editing, or the like of a printing target file such as a document file, and performs a printing setting or a printing instruction for the printer A (31) to update the FW 31a.

Specifically, first, the user U starts an application program for performing starting, editing, or the like of a printing target file such as a document file. Here, the application program to be started may be an application program related to a connected printer such as the application A (18) related to the printer A (31), or any other application programs. The application program to be started may be any application program that enables printing.

Next, the user U performs, by the operation unit 14, an operation of selecting the printer A (31) in the printing setting of the printing target file or an operation of giving a printing instruction to the printer A (31). In the sixth example, such an operation is treated as the check instruction operation in step S51 shown in FIG. 6 to perform processing. With the operation, the vendor assistance App 17 is started via the general-purpose printer driver 16, and the processing shown in FIG. 6 can be executed.

As described in the third example, with the operation of giving the printing instruction to the printer A (31), the general-purpose printer driver 16 converts the printing target file into printing data, and the vendor assistance App 17 receives the printing data from the general-purpose printer driver 16. Therefore, the determination processing in the sixth example means determination of the necessity of updating the FW 31a of the printer A (31) when printing data that is data to be processed by the printer is received from the general-purpose printer driver 16.

In addition, the general-purpose printer driver 16 starts the vendor assistance App 17 by the operation of performing the printing setting of the printer A (31). As a result, the determination processing in the sixth example may also mean determination of the necessity of updating the FW 31a of the printer A (31) when the vendor assistance App 17 is started by specifying the printer A (31) by the general-purpose printer driver 16.

Also in the sixth example, in the situation described in steps S59 and S60 in the fourth example, the update may be executed after the check by the user U, or the update may be automatically executed without the check by the user U.

In the sixth example of the update processing, in addition to the effect of the fourth example, effects that the time and effort of the check by the user U can be further reduced and the update of the firmware program of the printer can be executed are exhibited. Of course, the sixth example can be similarly applied to the fifth example.

### Other Modifications

The present disclosure is not limited to the embodiments described above, and can be appropriately modified without departing from the scope of the present disclosure. For example, the system configuration of the printing system, the configurations of the apparatuses configuring the system, the configurations of the programs included in the apparatuses, the processing procedures of the apparatuses, and the like are not limited to the exemplified ones. The printing system may also employ a network configuration in which a terminal apparatus is connected to a printer via a printing server. Embodiment 1 and Embodiment 2 may also be combined. In other words, the printing system may also support the updates on both the application program and the firmware program.

In the above-described embodiment, the printing apparatus is described as an example of an image processing apparatus, and the printing system is described as an example of an image processing system, and the image processing apparatus is not limited to the printing apparatus, and the image processing system is not limited to the printing system. Examples of an image processing apparatus other than the printing apparatus include various types of apparatuses that perform image processing, such as a scanner apparatus, a facsimile apparatus, and a projector apparatus. For any image processing apparatus, various examples and effects described in the above-described embodiment can be described by replacing the printing apparatus with another image processing apparatus. For example, when the image processing apparatus is a scanner apparatus, the general-purpose driver is a general-purpose scanner driver. According to the present disclosure, even in an environment where various types of image processing apparatuses perform image processing using a general-purpose driver that controls the image processing apparatus, it is possible to easily update a program related to the image processing apparatus provided by, for example, a vendor of the image processing apparatus.

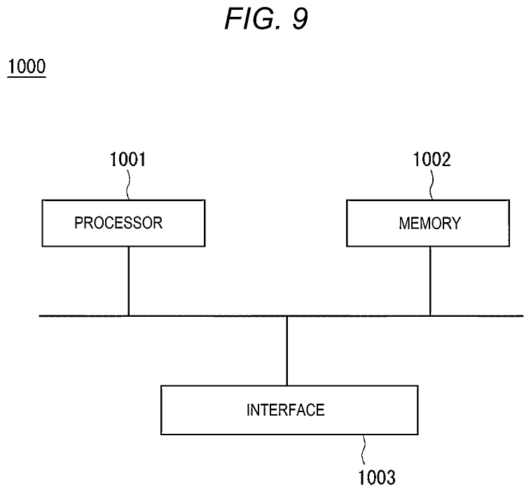

The apparatuses provided in the image processing system such as a printing system according to the embodiments described above may have, for example, the following hardware configuration. Here, examples of the apparatuses include a terminal apparatus, a download server, and each printer in the examples shown in FIGS. 1 and 5. FIG. 9 is a diagram illustrating an example of a hardware configuration of an apparatus.

An apparatus 1000 illustrated in FIG. 9 may include a processor 1001, a memory 1002, and an interface 1003. The interface 1003 may include, for example, a communication interface or an interface with an input and output apparatus, which are necessary depending on the apparatus.

The processor 1001 may be, for example, a CPU, a GPU, or a micro processor unit (MPU) also referred to as a microprocessor. The processor 1001 may include a plurality of processors. The memory 1002 is implemented by, for example, a combination of a volatile memory and a nonvolatile memory. Functions of the apparatuses are implemented by the processor 1001 reading a program stored in the memory 1002 and executing the program while exchanging necessary information via the interface 1003.

The program described above includes a command group (or software codes) for causing a computer to perform one or more functions described in the embodiment when the program is read by the computer. The program may be stored in a non-transitory computer-readable medium or a tangible storage medium. Examples of the computer-readable medium or the tangible storage medium include, but are not limited to, a random-access memory (RAM), a read-only memory (ROM), a flash memory, a solid-state drive (SSD), and other memory techniques. Further, examples of the computer-readable medium or the tangible storage medium include, but are not limited to, a CD-ROM, a digital versatile disc (DVD), a Blu-ray (registered trademark) disc, other optical disc storage, a magnetic cassette, a magnetic tape, a magnetic disk storage, or other magnetic storage devices. The program may be transmitted on a transitory computer-readable medium or a communication medium. Examples of the transitory computer-readable medium or the communication medium include, but are not limited to, a propagation signal of an electric, optical, acoustic, or another form.

The present disclosure is described with reference to the above-described embodiments. The present disclosure is not limited only to the configuration in the above-described embodiments, and it goes without saying that the present disclosure includes various variations, modifications, and combinations that can be achieved by those skilled in the art within the scope of the disclosure in the claims of the present application.

What is claimed is:

1. A non-transitory computer-readable storage medium storing a control program, the control program causing a computer to execute:
acquisition processing of acquiring apparatus information on an image processing apparatus from a general-purpose driver;
determination processing of determining, based on the acquired apparatus information, necessity of updating an external program related to the image processing apparatus; and
update processing of updating the external program when it is determined in the determination processing that the external program is required to be updated.

2. The non-transitory computer-readable storage medium storing the control program according to claim 1, wherein
the image processing apparatus is a printing apparatus.

3. The non-transitory computer-readable storage medium storing the control program according to claim 2, wherein
the control program is Print Support Application.

4. The non-transitory computer-readable storage medium storing the control program according to claim 1, wherein
in the acquisition processing, the apparatus information is acquired from attribute information that indicates an attribute of the image processing apparatus and is set by the general-purpose driver.

5. The non-transitory computer-readable storage medium storing the control program according to claim 1, wherein
in the update processing, in a case where it is determined in the determination processing that the external program is required to be updated, the update of the external program is executed when a user checks a result of the determining and the user instructs the update.

6. The non-transitory computer-readable storage medium storing the control program according to claim 1, wherein
in the determination processing, the necessity of updating the external program is determined when the image processing apparatus receives data to be processed from the general-purpose driver.

7. The non-transitory computer-readable storage medium storing the control program according to claim 1, wherein
the external program is a firmware program of the image processing apparatus.

8. The non-transitory computer-readable storage medium storing the control program according to claim 1, wherein
the external program is an application program installed in the computer.

9. The non-transitory computer-readable storage medium storing the control program according to claim 1, wherein
in the acquisition processing, the apparatus information is acquired from the general-purpose driver for each of a plurality of the image processing apparatuses.

10. A control apparatus comprising:
a general-purpose driver;
an acquisition processing unit configured to acquire apparatus information on an image processing apparatus from the general-purpose driver;
a determination processing unit configured to determine, based on the acquired apparatus information, necessity of updating an external program related to the image processing apparatus; and
an update processing unit configured to update the external program when the determination processing unit determines that the external program is required to be updated.

11. An update method comprising:
acquisition processing of acquiring apparatus information on an image processing apparatus from a general-purpose driver;
determination processing of determining, based on the acquired apparatus information, necessity of updating an external program related to the image processing apparatus; and
update processing of updating the external program when it is determined in the determination processing that the external program is required to be updated.
